(19) United States
(12) Patent Application Publication
(10) Pub. No.: US 2014/0215614 A1
(43) Pub. Date: Jul. 31, 2014

(54) SYSTEM AND METHOD FOR A SECURITY ASSESSMENT OF AN APPLICATION UPLOADED TO AN APPSTORE

(71) Applicant: SAMSUNG ELECTRONICS CO., LTD., Gyeonggi-do (KR)

(72) Inventors: Evgeny BESKROVNY, Ramat Gan (IL); Iris LEV ARI, Ramat-Hasharon (IL)

(73) Assignee: SAMSUNG ELECTRONICS CO., LTD., Gyeonggi-do (KR)

(21) Appl. No.: 13/753,555

(22) Filed: Jan. 30, 2013

(51) Int. Cl. G06F 21/56

(52) U.S. Cl. CPC G06F 21/563
USPC 726/23

(57) ABSTRACT

A method for assessing the level of security of an application to be uploaded to an App Store, comprises: (i) Providing a security system comprising an attack dictionary relevant to a specific device, information regarding security sensitivity grades of subsystems of said device and an Identifier, suitable to recognize the API's related to each of said subsystems and to inspect each line of the code to calculate the maximum security sensitivity grade for each information flow emanating from a given line of code; (ii) For each specific attack present in the attack dictionary, inspecting a code to determine whether the attack is attempted; and (iii) If a suspicion of attack is detected, taking corrective action.

### FIELD OF THE INVENTION

The present invention relates to the field of security. More particularly, the invention relates to an improved method and system for assessing the security threats that may be potentially posed by an application uploaded to an App Store.

### BACKGROUND OF THE INVENTION

In recent years software designed for Smart devices (hereinafter referred to as “applications”) has been made available in large numbers through the so-called “App Stores”, such as those run by Samsung, Google and Apple. Those App Stores allow independent developers to upload applications that were not developed under the control of the App Store owner. As a result, some developers have taken advantage of this platform to include malicious code in their applications, which can be used for a variety of malicious activities.

In the context of this application the term “App Store” is meant to include any web-based store that sells software suitable to be run on Smart devices and includes, for instance, Smart TV AppStores or Mobile AppStores.

Because very large numbers of applications are developed independently, the App Store owners only have very limited capability to prevent malicious exploitation. There is therefore an urgent and clear need to assure that the applications, which are uploaded to an App Store are not malicious.

So far the art has employed two main approaches in an attempt to deal with the problem described above:

(1) Scanning—is an approach that allows runtime analysis of the application in order to detect patterns of malicious activity.
(2) Malware—is an approach that allows a mobile device to contact a server in order to receive a security assessment of the installed application and so, if the application is unsafe, to be able to remove it.

The above approaches use run time analysis of the executable in order to reach a conclusion whether the application is malicious or not. This leads to a large number of inaccuracies since every application behaves differently and it is hard to drive the application into all the states in which it may function. Many malicious functions of an application may be dormant until triggered at some future time and may not be detected during runtime analysis of a closed application for which no knowledge of the actual code is available. For example, the malware can be activated by a command coming from the outside. This cannot be detected during the run time analysis lacking the knowledge that the code may receive a command from the outside.

For example, it is possible and easy to develop a widget for SmartTV that sends a large number of HTTP Requests to the URL, which was received through a backdoor. This may create a distributed denial of service attack emanating from a device which doesn't raise a suspicion. As a further example, it is possible and easy to create a malware application for the mobile phone that dials a premium phone number, or registers itself to paid services. This would inflate a customer's bill and lead him to a decision to leave a cellular provider.

It is therefore clear that it is necessary to provide a method and a system that overcomes the drawbacks of the prior arts, allowing a better and more in-depth analysis of potential threats contained in the software code of the application.

It is an object of the present invention to provide such a method and system, which performs a static code analysis (also known as “program analysis”) and inspects the code in its entirety.

It is another object of the invention to provide an inspection method and system which is capable of detecting a backdoor which can activate a malware.

Other objects and advantages of the invention will become apparent as the description proceeds.

### SUMMARY OF THE INVENTION

The present invention relates to a method for assessing the level of security of an application to be uploaded to an App Store, comprising:
a) providing rules in or relating to an SDK, with which the application must comply;
b) when an application is packaged by a developer for uploading to the App Store, analyzing the software code for compliance with said rules;
c) for each rule compiling a level of suspicion or confidence based on the level of compliance of the software code with the rule; and
d) compiling a suspicion or confidence rate of the application based on the suspicious behavior, if any, identified for each rule and embedding in the application code information representative of such suspicion or confidence rate.

The invention also relates to a method for preventing the distribution of applications containing malicious codes through an App Store, comprising performing steps a) through d) above, and thereafter:
e) uploading the application to the App Store and analyzing the suspicion rate therein; and
f) based on the results of the analysis of the suspicion rate allowing or refusing inclusion of the application in the App Store and/or taking additional or other corrective action.

In one embodiment of the invention the method further comprises contacting the developer of the application to obtain clarification for suspicious behavior found in the software code. This further step may be conveniently used to avoid “false positives”, i.e., situations where innocuous software code may appear, upon an automated analysis, as if it were malicious or potentially malicious.

The invention is not limited to applications intended for any specific device and includes, inter alia, applications to be uploaded to the App Store which are intended for a device selected from among smart phones, tablet PCs or Smart TV.

The invention also encompasses a system for distributing applications through an App Store, comprising:
i. rules in or relating to an SDK, with which the application must comply;
ii. packaging and uploading circuitry for uploading an application to the App Store;
iii. software analysis apparatus to analyze the software code for compliance with said rules;
iv. compilation means for compiling for each rule a level of suspicion or confidence based on the level of compliance of the software code with the rule;
v. software for compiling a suspicion or confidence rate of the application based on the suspicious behavior, if any, identified for each rule and embedding in the application code information representative of such suspicion or confidence rate.
vi. an uploader for uploading the application to the App Store and for analyzing the suspicion rate therein; and
vii. logic circuitry for allowing or refusing inclusion of the application in the App Store based on the results of the analysis of the suspicion rate and/or for taking additional or other corrective action.

### BRIEF DESCRIPTION OF THE DRAWINGS

In the drawings:

FIG. 1 schematically illustrates the uploading and analysis of an application intended for the Smart TV App Store.

### DETAILED DESCRIPTION OF THE INVENTION

The invention exploits the knowledge of the development platform of the application. For example the widgets for the Samsung Smart TV are developed using a special SmartTV SDK (www.samsungdforum.com), which also provides a development environment. The development environment sees the code of the developed application and can perform static analysis of the entire code to detect the potential malicious patterns.

The invention allows exploiting the full knowledge possessed by the AppStore owner about the system, in order to detect whether an application uploaded to the AppStore is suspicious or not. According to the invention the various components of the system are assigned a security sensitivity grade, according to their function and the sensitivity that the AppStore owner attaches to them. For example the Smart TV comprises the following subsystems: Camera, Microphone, persistent storage, Tuner, Display and etc. Each subcomponent is assigned a security sensitivity grade. For example the Camera and persistent storage are assigned the grade 5 (i.e., the highest grade), the Tuner and Display are assigned the grade 0 (the lowest grade) and the Microphone the grade 1.

Now the system contains an Identifier which is capable of recognizing the API's related to each of the subsystem. The Identifier is an entity that contains a full specification of the system that includes a set of exposed APIs, along with the sensitivity grade of each subsystem belonging to a device. Given that data the Identifier is capable to inspect each line of code and to calculate the sensitivity grade of the information flows emanating from that line, it may also specify the highest sensitivity grade as the one that represents said line. This Identifier is also capable of inspecting each line of the code and to calculate the maximum security sensitivity grade for each information flow emanating from a given line of code. Different Identifiers can be designed by the skilled person, as long as they fulfill the abovementioned role.

The AppStore security system also contains a full attack dictionary which is relevant for each specific device that may use applications downloaded from the AppStore. The attack dictionary can be developed by the AppStore owner or can be taken from an external source such as available from http://capec.mitre.org/data/slices/2000.html.

For each attack in the dictionary the AppStore security system contains the information about the system, which is needed to be known in order to recognize the attack. For example, if the attack is a sandbox penetration attempt, then the AppStore security system contains the information about how the sandbox is defined. For example, each widget that is installed on the system may perform file operations in the folder named WidgetFolder, and all the cache related to the widget is stored under the key uniquely identified by the widget name. The same is also true about the temporary files and downloads directory.

Now, as explained above, the AppStore security system is equipped with a Detector which for each specific attack is capable to see whether it is attempted in the code. The Detector is a software entity that is capable to detect whether the attack is attempted, regardless of the sensitivity grades. The data it uses is the attack dictionary and the system specification that includes more attack specific definitions, such as sandbox definitions and the like. Different Detectors can be designed by the skilled person, as long as they fulfill the abovementioned role. In the specific context of the sandbox the Detector needs to detect at least one information flow which contains a file access API that tries to access file outside the permitted area.

Thus, in the example of a Smart TV that comes with hardware such as a microphone, a camera, the capability to record from the screen, etc. the SDK according to the invention uses a restricted language, and the API used by the developer employs a semantic that is fully known to the AppStore owner. By knowing the functional specifications of the environment it is known that all the written widgets are running in the sandboxed environment. All this knowledge combined allows the AppStore security system to detect applications that touch various entities in the system such as the camera or microphone, attempts to penetrate the sandbox.

According to the invention the development environment (Smart TV for example) is augmented with a rule-based engine that performs static analysis of the code. Such static analysis detects and informs its user of any unusual behavior/performance of the application. For example:
A rule looks for the usage of certain library API's that were reported by the community as the ones that facilitate hacker attacks.
A rule also performs pattern mining. It may detect a thread that listens to a non-standard port that might raise a suspicion of being a backdoor. It also detects a code that suggests that the application is going to be involved in a heavy network traffic exchange or works intensively with the files.

Different rules may be applied as applicable for scrutinizing the code of the developed application, as will be apparent to the skilled person and, therefore is not described herein in detail, for the sake of brevity.

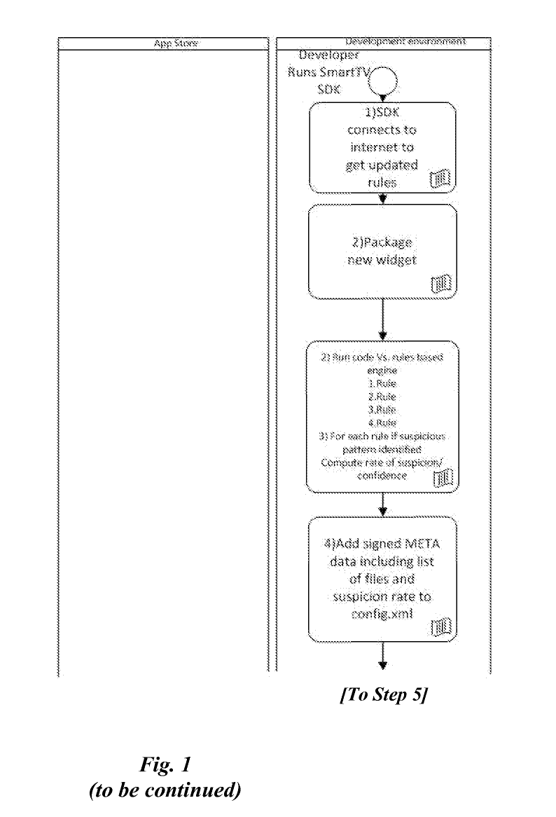

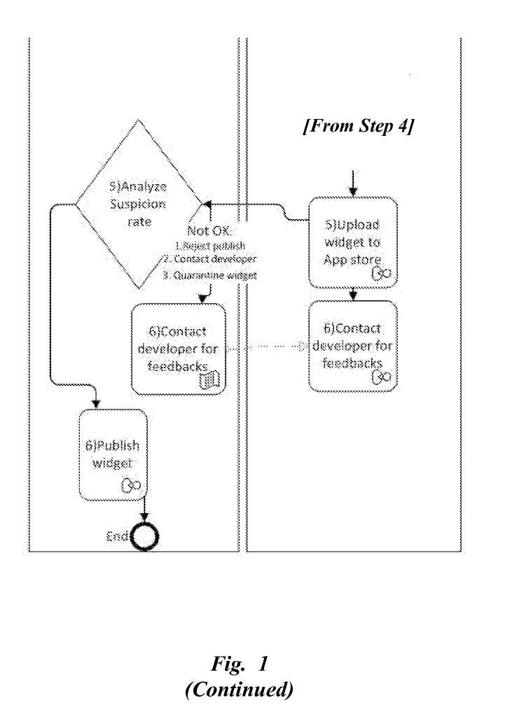

The method of the invention can be illustrated with reference to FIG. 1, which shows the following steps:
1) The development environment accepts a file with the rules that describe what to look for in the code. Illustrative examples of attacks that can be detected by the rules engine are, for instance:
   i. Sandbox violation through the opened APIs supplied by the SDK. The APIs include obvious APIs such as file manipulations and also not obvious APIs i.e those where data controllable by attacker ends up in the persistent storage. (Javascript)
   ii. Sandbox violation via implicit means like cache poisoning, temp folder poisoning, downloads folder poisoning. The widget may download or include external resources which have the same name as resources stored on the TV but are older and have known vulnerabilities. If these resources are downloaded from the attacker server they may override the TV resources. For example if the TV has a single storage place for Javascript libraries like JQuery it is possible to download old version of JQuery with the same names and it will override the latest version. (Javascript)
   iii. JSON evaluation. JSON evaluation performs a code execution that can be received from the outside and is not known apriori. We can detect that. (Javascript)
   iv. Unsafe HTML that contains IFrame inclusion, CSS inclusion, IMG inclusion where the URLs are built in a suspicious ways (like contain parameters and/or go to suspicious sites). This is done by analyzing HTML.
   v. Communication with external entities whose domain is different than a primary domain.
   vi. UI redressing attacks such as clickJacking and others.
   vii. Port scanning attacks done by the malware.
2) During the development of the application the user needs to package the application and this is the step which may be used for applying a static analysis of the code. This needs to be done when the widget is packaged before sending it to the AppStore, since packaging is normally the stage when the coding is done and the version is more or less stable.
3) The security analysis collects the information and based on it gives a confidence/suspicion grade to the application. All the attack patterns can be graded according to any suitable system. For instance, a grading similar to that of the Common Vulnerability Scoring System (CVSS) can be used. (CVSS is a vulnerability scoring system designed to provide an open and standardized method for rating IT vulnerabilities—see: http://www.first.org/cvss). This grade assesses the severity of potential attack. The grade can be dynamic and, for example it is possible to use a statistics about false positives collected by the AppStore and derive a grade from it.
4) The environment then signs the metadata that contains details of the files being analyzed and of the issues that were found. Although other signing schemes can be used, normal signing computes the hash of the contents and then uses a private key for signing. The hash guarantees that it can't be modified.
5) Then if the application is going to be uploaded to the application store, the server will receive that information, which allows it to see whether all the files in the package passed through the static analysis stage and what is the suspicion grade of the application.

The metadata produced by the development environment may contain the descriptive information about the developer of the application. The information includes origin IP, domain name, and other information that may help to identify the developer in the future.

### Example

In the example shown below the widget tries to get access to the restricted file by exploiting the existing security bug in the SmartTV. The static analyzer will analyze all the parameters in the widget and will detect that the parameter sendUrl contains potentially unsafe value.

var sendUrl = “file:///RestrictedFolder/PasswordFile”;
request = new XMLHttpRequest( );
request.open(‘GET’, sendUrl, false);
request.send( );

All the above description has been provided for the purpose of illustration and is not meant to limit the invention in any way. The invention presents significant advantages over the existing prior art. For example it sees the entire code and therefore it wouldn't miss application states from which the attacks occur.

1. A method for assessing the level of security of an application to be uploaded to an App Store, comprising:
i. Providing a security system comprising an attack dictionary relevant to a specific device, information regarding security sensitivity grades of subsystems of said device and an Identifier, suitable to recognize the API's related to each of said subsystems and to inspect each line of the code to calculate the maximum security sensitivity grade for each information flow emanating from a given line of code;
ii. For each specific attack present in the attack dictionary, inspecting a code to determine whether the attack is attempted; and
iii. If a suspicion of attack is detected, taking corrective action.

2. A method according to claim 1, wherein the Identifier is suitable to inspect each line of the code and to calculate the maximum security sensitivity grade for each information flow emanating from a given line of code.

3. A method according to claim 1, comprising
d) providing rules in or relating to an SDK, with which the application must comply;
e) when an application is packaged by a developer for uploading to the App Store, analyzing the software code for compliance with said rules;
f) for each rule compiling a level of suspicion or confidence based on the level of compliance of the software code with the rule; and
g) compiling a suspicion or confidence rate of the application based on the suspicious behavior, if any, identified for each rule and embedding in the application code information representative of such suspicion or confidence rate.

4. A method for preventing the distribution of applications containing malicious codes through an App Store, comprising performing the process of claim 1 and thereafter:
h) uploading the application to the App Store and analyzing the suspicion rate therein; and
i) based on the results of the analysis of the suspicion rate allowing or refusing inclusion of the application in the App Store and/or taking additional or other corrective action.

5. A method according to claim 1, further comprising contacting the developer of the application to obtain clarification for suspicious behavior found in the software code.

6. A method according to claim 1, wherein the application to be uploaded to the App Store is intended for a device selected from among smart phones, tablet PCs or Smart TV.

7. A system for distributing applications through an App Store, comprising:
i. A security system comprising an attack dictionary relevant to a specific device, information regarding security sensitivity grades of subsystems of said device and an Identifier, suitable to recognize the API's related to each of said subsystems and to inspect each line of the code to calculate the maximum security sensitivity grade for each information flow emanating from a given line of code; and
ii. An Inspector, for inspecting a code to determine, for each specific attack present in the attack dictionary, whether the attack is attempted.

8. A security system according to claim 7, comprising:
iii. rules in or relating to an SDK, with which the application must comply;
iv. packaging and uploading circuitry for uploading an application to the App Store;
v. software analysis apparatus to analyze the software code for compliance with said rules;
vi. compilation means for compiling for each rule a level of suspicion or confidence based on the level of compliance of the software code with the rule;
vii. software for compiling a suspicion or confidence rate of the application based on the suspicious behavior, if any, identified for each rule and embedding in the application code information representative of such suspicion or confidence rate.
viii. an uploader for uploading the application to the App Store and for analyzing the suspicion rate therein; and
ix. logic circuitry for allowing or refusing inclusion of the application in the App Store based on the results of the analysis of the suspicion rate and/or for taking additional or other corrective action.
